(19) United States
(12) Patent Application Publication
(10) Pub. No.: US 2012/0291949 A1
(43) Pub. Date: Nov. 22, 2012

(54) Method and Apparatus for Manufacturing an Absorbent Article with Crosslinked Elastic Components

(76) Inventors: Oomman Painummoottil Thomas, Alpharetta, GA (US); Robert Edward Abernathy, Neenah, WI (US)

(21) Appl. No.: 13/112,640

(22) Filed: May 20, 2011

(51) Int. Cl. B32B 37/14; B32B 37/06; B32B 37/02

(52) U.S. Cl. 156/275.5; 156/380.9

(57) ABSTRACT

Generally, a method and apparatus for forming an elastic portion of an absorbent article is disclosed. An elastic material web having at least one crosslinkable elastic styrenic block copolymer sized to correspond to at least one discrete elasticized portion of the absorbent article is provided. The elastic material web may be unwound or otherwise supplied and then attached to a continuous moving web to form at least one discrete elasticized portion of the absorbent article. The elastic material web is crosslinked by subjecting the elastic material web to electromagnetic radiation with an electron beam processing unit sufficient to provide a crosslinked elastic styrenic block copolymer. The electromagnetic radiation is sized to correspond to at least one discrete elasticized portion of the absorbent article. A variety of absorbent article components may possess elastic characteristics, including waistbands, leg/cuff gasketing, side panels, and outer covers.

### BACKGROUND

Elastic laminates or composites are commonly incorporated into products (e.g., diapers, training pants, garments, etc.) to improve their ability to better fit the contours of the body. For example, an elastic laminate may be formed from the elastic film and one or more nonwoven web facings. The nonwoven web facing may be joined to the elastic film while the film is in a stretched condition so that the nonwoven web facing can gather between the locations where it is bonded to the film when it is relaxed. The resulting elastic composite is stretchable to the extent that the nonwoven web facing gathered between the bond locations allows the elastic film to elongate. Unfortunately, however, the stretchable nature of the composites may cause problems during the manufacturing process of the absorbent article products into which they are incorporated. For example, the force required to unwind the rolled composites may at least partially extend the elastic composite while the absorbent article is in tension. This partial extension of the stretchable composite can make it difficult to properly measure and position the desired quantity of the elastic composite in the final product.

Additionally, elastic composites are typically the most expensive component in personal care products such as diapers, training or swim pants, adult incontinence garments, feminine hygiene products and the like. Important properties of elastic laminates include providing sufficient elastic tension at various degrees of elongation during use, and providing sufficient recovery upon stress relaxation.

There is a further need or desire for apparatus and methods for making elastic laminates which perform better at a lower cost.

### SUMMARY

Generally, a method and apparatus for forming an elasticized absorbent article is disclosed. An elastic material web having at least one cross-linkable elastic styrenic block copolymer sized to correspond to at least one discrete elasticized portion of the absorbent article is supplied. The elastic material web may be unwound or otherwise supplied and then attached on a continuous moving web to form at least one discrete elasticized portion of an absorbent article. The elastic material web is crosslinked by subjecting the elastic material web to electromagnetic radiation with an electromagnetic radiation source sufficient to provide a crosslinked elastic styrenic block copolymer. The electromagnetic radiation source is sized to provide electromagnetic radiation that is sized to correspond to at least one discrete elasticized portion of the absorbent article. the at least one discrete elasticized portion of the absorbent article is crosslinked may be after being attached to the base web. As is well known to those skilled in the art, a variety of absorbent article components may possess elastic characteristics, such as waistbands, leg/cuff gasketing, side panels, outer covers, stretch ears, flaps, and so forth. The crosslinked elastic material may be employed for use in any of such components.

The elastic material web may also contain at least one facing layer. The facing layer may contain a nonwoven web selected from meltblown, spunbond and combinations thereof. The elastic material web may also contain at least one strength layer. The strength layer may contain a crosslinkable or non-crosslinkable thermoplastic polymer.

The electromagnetic radiation unit may operate between about 50 to about 500 kV, more desirably between about 100 to about 300 kV, or about 150 kV. The electron beam processing unit may deliver about 2 to about 30 MRads, more desirably about 5 to about 15 MRads or about 10 MRads of electron beam radiation to the elastic material web.

### BRIEF DESCRIPTION

A full and enabling disclosure thereof, directed to one of ordinary skill in the art, is set forth more particularly in the remainder of the specification, which makes reference to the appended figures in which:

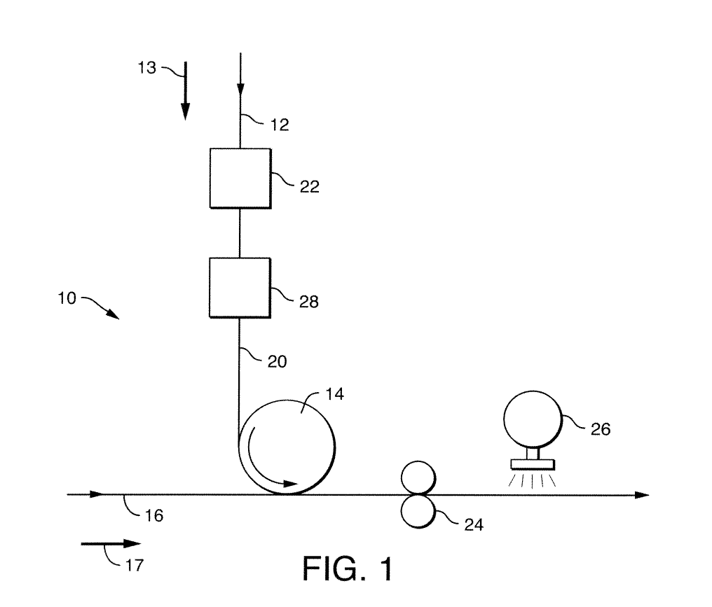

FIG. 1 illustrates an exemplary apparatus and method for making an absorbent article.

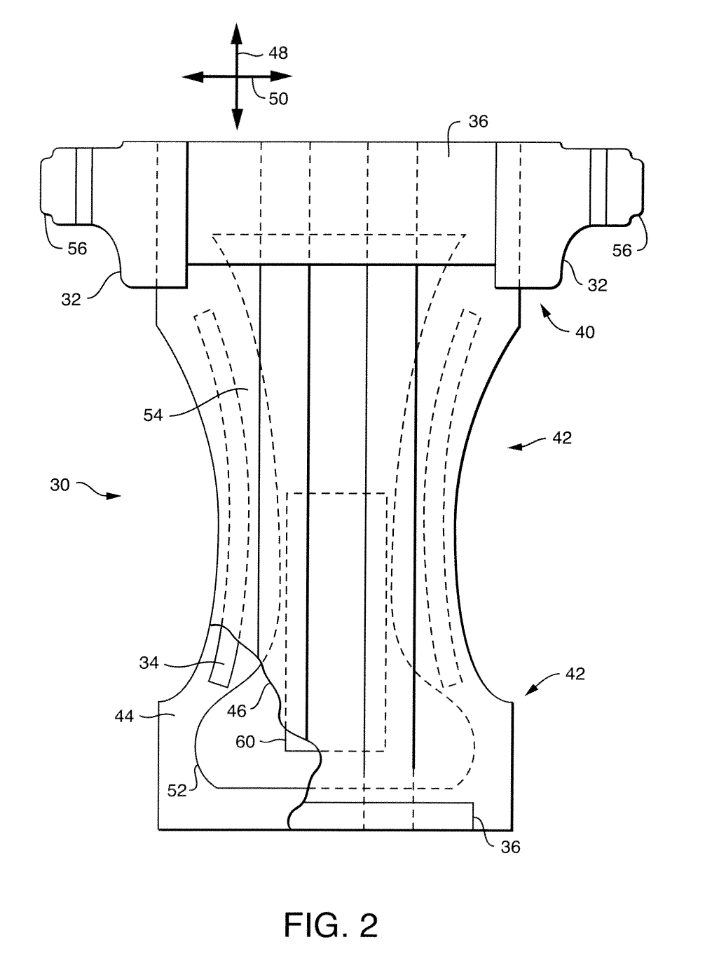

FIG. 2 illustrates a perspective view of an absorbent article that may be formed in accordance with the exemplary apparatus of FIG. 1.

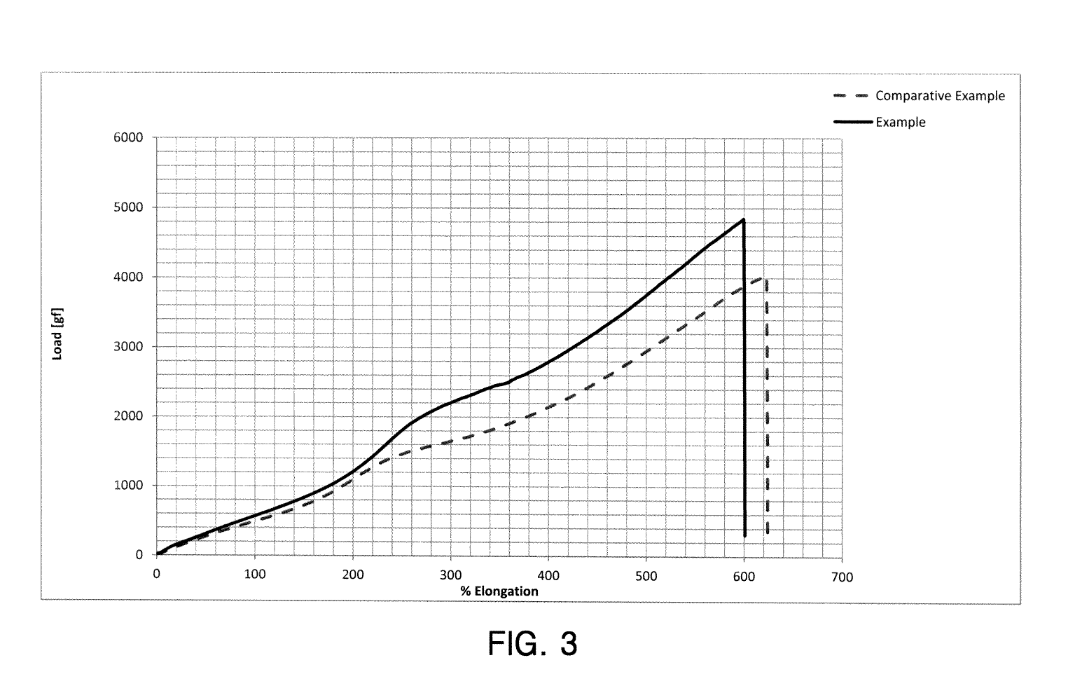

FIG. 3 illustrates a graph depicting normalized load as a function of elongation for materials for use in the absorbent article described herein.

Repeat use of reference characters in the present specification and drawing is intended to represent same or analogous features or elements.

### DETAILED DESCRIPTION

Reference now will be made in detail to various embodiments of the invention, one or more examples of which are set forth below. Each example is provided by way of explanation, not limitation of the invention. In fact, it will be apparent to those skilled in the art that various modifications and variations may be made in the present disclosure without departing from the scope or spirit of the invention. For instance, features illustrated or described as part of one embodiment, may be used on another embodiment to yield a still further embodiment. Thus, it is intended that the present invention cover such modifications and variations.

Generally, a method and apparatus for forming an elastic portion of an absorbent article is disclosed. An elastic material web having at least one cross-linkable elastic styrenic block copolymer sized to correspond to at least one discrete elasticized portion of the absorbent article is supplied. The elastic material web is applied to the absorbent article to form the at least one discrete elasticized portion of the absorbent article. The elastic material web is crosslinked by subjecting the elastic material web to electromagnetic radiation with an electron beam processing unit sufficient to provide a crosslinked elastic styrenic block copolymer.

Referring to FIG. 1, there is representatively illustrated an exemplary method and apparatus 10 to form an elastic portion of an absorbent article. The method and apparatus 10 may be utilized to apply and attach an elastic material web to a continuously moving article web 16. An article web 16 may be a continuously moving web of interconnected absorbent articles. Alternatively, the article web 16 may be any substantially continuous portion of material that may benefit from the addition of separately attached components, such as a woven or nonwoven material, and may include several layers of material or one layer of material, or combinations thereof. An elastic material web 12 having at least one cross-linkable elastic styrenic block copolymer and sized to correspond to at least one discrete elasticized portion of the absorbent article by a cutting assembly 28 is supplied in the direction of arrow 13 by suitable web transport devices (not shown).

As is well known to those skilled in the art, a variety of absorbent article components may possess elastic characteristics, such as waistbands, leg/cuff gasketing, side panels, stretch ears, flaps, outer covers, and so forth. The crosslinked elastic material may be employed for use in any of such components. Referring to FIG. 2, an example of one embodiment of a disposable absorbent article 30 is shown that generally defines a front waist section 38, a rear waist section 40, and an intermediate section 42 that interconnects the front and rear waist sections. The front and rear waist sections 38 and 40 include the general portions of the diaper which are constructed to extend substantially over the wearer's front and rear abdominal regions, respectively, during use. The intermediate section 42 of the diaper includes the general portion of the diaper that is constructed to extend through the wearer's crotch region between the legs. Thus, the intermediate section 42 is an area where repeated liquid surges typically occur in the diaper.

The absorbent article 30 includes, without limitation, an outer cover, or backsheet 44, a liquid permeable bodyside liner, or topsheet 46, positioned in facing relation with the backsheet 44, and an absorbent core body, or liquid retention structure, 52, such as an absorbent pad, which is located between the backsheet 44 and the topsheet 46. The backsheet 44 defines a length, or longitudinal direction 48, and a width, or lateral direction 50 which, in the illustrated embodiment, coincide with the length and width of the absorbent article 30. The liquid retention structure 52 generally has a length and width that are less than the length and width of the backsheet 44, respectively. Thus, marginal portions of the absorbent article 30, such as marginal sections of the backsheet 44 may extend past the terminal edges of the liquid retention structure 52. In the illustrated embodiments, for example, the backsheet 44 extends outwardly beyond the terminal marginal edges of the liquid retention structure 52 to form side margins and end margins of the absorbent article 30. The topsheet 46 is generally coextensive with the backsheet 44 but may optionally cover an area that is larger or smaller than the area of the backsheet 44, as desired.

To provide improved fit and to help reduce leakage of body exudates from the absorbent article 30, the diaper side margins and end margins may be elasticized with suitable elastic members, as further explained below. For example, as representatively illustrated in FIG. 2, the absorbent article 30 may include leg/cuff gasketing 34 constructed to operably provide tension to the side margins of the absorbent article 30 and closely fit around the legs of the wearer to reduce leakage and provide improved comfort and appearance. Waistbands 36 are employed that provide a resilient, comfortably close fit around the waist of the wearer. The crosslinked elastic material is suitable for use as the leg/cuff gasketing 34 and/or waistbands 36. Exemplary of such materials are composite sheets that either comprise or are adhered to the backsheet, such that elastic constrictive forces are imparted to the backsheet 44.

As is known to those skilled in the art, fastening means, such as hook and loop fasteners, may be employed to secure the absorbent article 30 on a wearer. Alternatively, other fastening means, such as buttons, pins, snaps, adhesive tape fasteners, cohesives, fabric-and-loop fasteners, or the like, may be employed. In the illustrated embodiment, the absorbent article 30 includes a pair of side panels 32 (or ears) to which the fasteners 56, indicated as the hook portion of a hook and loop fastener, are attached. Generally, the side panels 32 are attached to the side edges of the diaper in one of the waist sections 38, 40 and extend laterally outward therefrom. The side panels 32 may contain the elastic material. Examples of absorbent articles that include side panels and selectively configured fastener tabs are described in PCT Patent Application WO 95/16425 to Roessler; U.S. Pat. No. 5,399,219 to Roessler et al.; U.S. Pat. No. 5,540,796 to Fries; and U.S. Pat. No. 5,595,618 to Fries, each of which is incorporated herein in its entirety by reference thereto for all purposes.

The absorbent article 30 may also include a surge management layer 58, located between the topsheet 46 and the liquid retention structure 52, to rapidly accept fluid exudates and distribute the fluid exudates to the liquid retention structure 52 within the absorbent article 30. The absorbent article 30 may further include a ventilation layer (not illustrated), also called a spacer, or spacer layer, located between the liquid retention structure 52 and the backsheet 44 to insulate the backsheet 44 from the liquid retention structure 52 to reduce the dampness of the garment at the exterior surface of a breathable outer cover, or backsheet,44. Examples of suitable surge management layers are described in U.S. Pat. No. 5,486,166 to Bishop and U.S. Pat. No. 5,490,846 to Ellis.

As representatively illustrated in FIG. 2, the disposable absorbent article 30 may also include a pair of containment flaps 54 which are configured to provide a barrier to the lateral flow of body exudates. The containment flaps 54 may be located along the laterally opposed side edges of the diaper adjacent the side edges of the liquid retention structure 52. Each containment flap 54 typically defines an unattached edge that is configured to maintain an upright, perpendicular configuration in at least the intermediate section 42 of the absorbent article 30 to form a seal against the wearer's body. The containment flaps 54 may extend longitudinally along the entire length of the liquid retention structure 52 or may only extend partially along the length of the liquid retention structure. When the containment flaps 54 are shorter in length than the liquid retention structure 52, the containment flaps 54 can be selectively positioned anywhere along the side edges of the absorbent article 30 in the intermediate section 42. Such containment flaps 54 are generally well known to those skilled in the art. For example, suitable constructions and arrangements for containment flaps 54 are described in U.S. Pat. No. 4,704,116 to Enloe.

The absorbent article 30 may be of various suitable shapes. For example, the absorbent article may be a diaper, which may have an overall rectangular shape, T-shape or an approximately hour-glass shape. Other suitable components which may be incorporated on absorbent articles may include waist flaps and the like which are generally known to those skilled in the art. Examples of diaper configurations suitable for use in connection with the elastic materials described herein may include other components suitable for use on diapers as described in U.S. Pat. No. 4,798,603 to Meyer, et al.; U.S. Pat. No. 5,176,668 to Bernardin; U.S. Pat. No. 5,176,672 to Bruemmer, et al.; U.S. Pat. No. 5,192,606 to Proxmire, et al.; and U.S. Pat. No. 5,509,915 to Hanson, et al., which are incorporated herein in their entirety by reference thereto for all purposes.

The various regions and/or components of the absorbent article 30 may be assembled together using any known attachment mechanism, such as adhesives; ultrasonic bonds; thermal bonds; microwave bonding; extrusion coating; etc. Suitable adhesives may include, for instance, hot melt adhesives, pressure-sensitive adhesives, and so forth. When utilized, the adhesive may be applied as a uniform layer, a patterned layer, a sprayed pattern, or any of separate lines, swirls or dots. As illustrated in FIG. 2, for example, the topsheet 46 and backsheet 44 may be assembled to each other and to the liquid retention structure 52 with lines of adhesive, such as a hot melt, pressure-sensitive adhesive. Similarly, other diaper components, such as the leg/cuff gasketing 34, waistband 36, fastening members 56, and surge layer 60 may be assembled into the article by employing the above-identified attachment mechanisms.

Although various configurations of an absorbent article have been described above, it should be understood that other diaper and absorbent article configurations are also included within the scope of the present invention. In addition, the present invention is by no means limited to diapers. In fact, any other absorbent article may be formed in accordance with the present invention, including, but not limited to, other personal care absorbent articles, such as training pants, absorbent underpants, adult incontinence products, feminine hygiene products (e.g., sanitary napkins), swim wear, baby wipes, and so forth; medical absorbent articles, such as garments, fenestration materials, underpads, bandages, absorbent drapes, and medical wipes; food service wipers; clothing articles; and so forth. Several examples of such absorbent articles are described in U.S. Pat. No. 5,649,916 to DiPalma, et al.; U.S. Pat. No. 6,110,158 to Kielpikowski; and U.S. Pat. No. 6,663,611 to Blaney, et al., which are incorporated herein in their entirety by reference thereto for all purposes. Still other suitable articles are described in U.S. Patent Application Publication No. 2004/0060112 A1 to Fell et al., as well as U.S. Pat. No. 4,886,512 to Damico et al.; U.S. Pat. No. 5,558,659 to Sherrod et al.; U.S. Pat. No. 6,888,044 to Fell et al.; and U.S. Pat. No. 6,511,465 to Freiburger et al., all of which are incorporated herein in their entirety by reference thereto for all purposes.

As described above, an elastic material web containing at least one cross-linkable elastic styrenic block copolymer is provided to form an elastic portion of an absorbent article. As illustrated in FIG. 1, the elastic material web may initially be provided in the form of a continuously moving elastic material web 12, which may then be processed by the method and apparatus 10 into individual elastic material webs that are sized into the discrete components as described above. Suitable unwinds are well known to those skilled in the art, and can include a driven unwind, or a passive unwind that relies on the apparatus 10 to draw the web 12 through the process. Alternatively, the web 12 may pass through the apparatus 10 via a combination of a driven unwind and the draw of the apparatus 10. The elastic material web may be prepared upstream on the apparatus or supplied on a roll to be unwound. Suitable techniques for formation of the elastic material web are described in U.S. Pat. No. 7,384,491 to Fitts, Jr. et al. which is incorporated herein in its entirety by reference thereto for all purposes. A die is generally used to extrude the crosslinkable elastic copolymer in the form of a film, a foam layer, an array of strands or fibers (e.g. substantially parallel strands or fibers), an array of ribbons, a nonwoven web (e.g. a spunbond web, meltblown web, or other nonwoven web), or a combination of the foregoing.

The crosslinkable elastic copolymer is more desirably a thermoplastic elastomer which is not yet crosslinked. Crosslinking of the copolymer prior to extrusion may detrimentally impact the material flow properties of the material, thereby rendering the copolymer unsuitable for extrusion.

The crosslinkable elastic copolymer may include a crosslinkable styrenic block copolymer. Suitable styrenic block copolymer elastomers include styrene-diene and styrene-olefin block copolymers. Styrene-diene block copolymers include di-block, tri-block, tetra-block and other block copolymers, and may include without limitation styrene-isoprene, styrene-butadiene, styrene-isoprene-styrene, styrene-butadiene-styrene, styrene-isoprene-styrene-isoprene, and diene-styrene-diene, styrene-butadiene-styrene-butadiene block copolymers. Styrene-diene polymers which include butadiene (e.g. styrene-butadiene-styrene triblock copolymers) are particularly suitable. One commercially available styrene-butadiene-styrene block copolymer is VECTOR 8508, available from Dexco Polymers L.P. of Houston, Tex. Examples of styrene-isoprene-styrene copolymers include VECTOR 4111A and 4211A, available from Dexco Polymers L.P. Styrene-olefin block polymers include without limitation styrene-diene block copolymers in which the diene groups have been totally or partially selectively hydrogenated, including without limitation styrene-(ethylene-propylene), styrene-(ethylene-butylene), styrene-(ethylene-propylene)-styrene, styrene-(ethylene-butylene)-styrene, styrene-(ethylene-propylene)-styrene-(ethylene-propylene), and styrene-(ethylene-butylene)-styrene-(ethylene-butylene) block copolymers.

In the above formulas, the term “styrene” indicates a block sequence of styrene repeating units; the terms “isoprene” and “butadiene” indicate block sequences of diene units; the term “(ethylene-propylene)” indicates a block sequence of ethylene-propylene copolymer units, and the term “(ethylene-butylene)” indicates a block sequence of ethylene-butylene copolymer units. The styrene-diene or styrene-olefin block copolymer should have a styrene content of about 10 to about 50% by weight, more desirably about 15 to about 25% by weight, and should have a number average molecular weight of at least about 15,000 grams/mol, more desirably about 30,000 to about 120,000 grams/mol, or about 50,000-80,000 grams/mol. Styrene-diene block copolymers may be particularly advantageous for subsequent crosslinking due to the additional unsaturation.

Other suitable crosslinkable styrenic block copolymers include styrene-diene block copolymers and styrene-olefin block copolymers such as those described above having varying levels of unsaturation.

The molecular weight of the styrenic block copolymer should be low enough that the styrenic block copolymer or polymer mixture can be formed into an elastic material web without inducing significant crosslinking during layer formation. The styrenic block copolymer or polymer mixture should be suitable for processing at temperatures below about 220° C., more desirably below about 210° C., or about 125-200° C. The molecular weight range needed to achieve this objective will vary depending on the type of styrenic block copolymer, the amount and type of additional ingredients, and the characteristics of the elastic material web being formed.

The elastic material web may include at least about 25% by weight of the styrenic block copolymer elastomer, or at least about 40% by weight, or at least about 50% by weight, or at least about 75% by weight. The elastic material web may include up to 100% by weight of the styrenic block copolymer elastomer, or up to about 99.5% by weight, or up to about 95% by weight, or up to about 90% by weight, or up to about 80% by weight, or up to about 70% by weight. The styrenic block copolymer elastomer may include one or more styrenic block copolymers mixed together.

Alternatively or additionally, the crosslinkable elastic copolymer may include a crosslinkable olefin elastomer. Suitable crosslinkable olefin elastomers include semi-crystalline polyolefin plastomer available under the trade name VISTAMAXX from ExxonMobil Chemical Co. of Houston, Tex. Other suitable crosslinkable olefin elastomers include propylene-ethylene copolymers available under the trade name VERSIFY from Dow Chemical Co. of Midland, Mich.

Optional additional ingredients may form the balance of the elastic material web. Such ingredients include without limitation single-site catalyzed ethylene-alpha olefin copolymer elastomers having a density of less than about 0.915 grams/³, more desirably about 0.860-0.900 grams/cm³, or about 0.865-0.895 grams/cm³. These ethylene-alpha olefin copolymers may be formed using a C₃-C₁₂ alpha-olefin comonomer, more desirably a butene, hexene or octene comonomer. The amount of alpha olefin comonomer is about 5-25% by weight of the copolymer, more desirably 10-25% by weight, and varies with the desired density. Suitable single-site catalyzed ethylene-alpha olefin copolymers are made and sold by Dow Chemical Co. under the trade names AFFINITY and ENGAGE, and by ExxonMobil Chemical Co., under the trade names EXACT and EXCEED.

Other optional ingredients include non-elastomeric polymers such as polyethylene, polypropylenes and other polyolefins, as well as other elastomeric polymers. When present, inelastic polymers should be employed in relatively minor amounts so as not to overcome the elastomeric characteristics of the crosslinked elastic material web.

Other optional ingredients include processing aids which assist in formation of the elastic material web at temperatures low enough to avoid significant premature crosslinking. One suitable processing aid is a polyolefin wax, for instance a branched or linear low density polyethylene wax having a density of about 0.860-0.910 grams/cm³, and a melt index of about 500-4000 grams/10 min. measured using ASTM D1238 at a temperature of 190° C. and a load of 2160 grams. Examples of polyethylene waxes include EPOLENE C-10 available from the Eastman Chemical Co. of Kingsport, Tenn. and PETROTHANE NA601 available from Quantum Chemical Co. of Alberta, Canada. Other examples include wax-like high melt index (low molecular weight) single-site catalyzed olefin polymers available from Dow Chemical Co. under the trade name AFFINITY, for instance AFFINITY 1900 and 1950 polyolefin plastomers.

Another suitable processing aid is a styrene-based hydrocarbon tackifier having an average molecular weight of about 500-2500. One example is REGALREZ 1126 tackifier, available from Eastman Chemical Co. Castor oil is another suitable processing aid. Mineral oil is a further suitable processing aid.

Processing aids may together constitute about 0.1-50% by weight, more desirably about 5-30% by weight of the elastic material web, or about 10-20% by weight of the elastic material web. When castor oil is used, it should be present in amounts suitable for crosslinking aids.

Other optional ingredients include crosslinking aids, i.e., additives which assist in crosslinking the formed elastic material web. One or more crosslinking aids may together constitute about 0.1-10% by weight, more desirably about 0.5-5% by weight of the elastic material web. Castor oil is one such aid. Castor oil is a natural triglyceride that contains three oleic chains, each having one degree of unsaturation. Castor oil is polymerizable if subjected to an initiation source such as electron beam radiation. Castor oil is thermally stable at up to about 275° C., and can be processed in an extruder along with the styrenic block copolymer elastomer without degrading. The resulting elastic material web can be polymerized (crosslinked) using a high energy radiation source, such as an electron beam. Due to the presence of three unsaturated chains on each castor oil molecule, the castor oil will assist three-dimensional crosslinking through chain transfer reactions with adjacent polymer chains.

Other crosslinking aids include without limitation multifunctional acrylate and allyl derivatives such as diethylene glycol dimethacrylate, dimethylene glycol acrylate, trimethylpropane diallyl ether, triethylene glycol dimethacrylate, and other multifunctional monomers which have adequate thermal stability in a melt extrusion process. Other crosslinking aids include polymers and oligomers having secondary carbons in a polymer backbone or side chains, as well as unsaturated double bonds.

Other optional ingredients include particulate inorganic or organic fillers. Generally, the filler particles have mean particle sizes of about 0.5-8 microns, more desirably about 1-2 microns. Suitable inorganic fillers include calcium carbonate (CaCO₃), various kinds of clay, silica (SiO₂), alumina, barium sulfate, sodium carbonate, talc, magnesium sulfate, titanium dioxide, zeolites, aluminum sulfate, cellulose-type powders, diatomaceous earth, calcium oxide, magnesium oxide, aluminum hydroxide and the like. Suitable organic fillers include cellulose, cyclodextrins, and cage molecules (e.g. polyhedral oligomeric silsesquioxane nanostretched chemicals). When used, the filler particles may constitute about 20-75% by weight of the elastic film, more desirably about 30-60% by weight.

Thermal polymerization of diene-containing polymers is typically accomplished by a free radical polymerization mechanism which involves initiation, propagation and termination. Free radical initiators such as peroxides are typically used for the initiation of free radical polymerization. When heated, the initiator breaks and creates a radical which attacks the double-bond in the diene-containing segments of the polymer which in turn creates another radical which propagates the process. Crosslinking of styrenic block copolymers may be achieved by exposing diene bonds located in the rubbery domains of the styrenic block copolymer (i.e., the butadiene or isoprene segments) to a high energy source such as electron beam radiation. Upon exposure to the high energy source, the diene bonds break forming free radicals which recombine in new orientations forming a crosslinked molecular network.

The elastic material web may be mono- or multi-layered. Multilayer films may be prepared by co-extrusion of the layers, extrusion coating, or by any conventional layering process. Such multilayer films normally contain at least one base layer and at least one strength layer, but may contain any number of layers desired. For example, the multilayer film may be formed from a base layer and one or more strength layers, wherein the base layer is formed from a styrenic block copolymer. In such embodiments, the strength layer(s) may be formed from any film-forming polymer. If desired, the strength layer(s) may contain a softer, lower melting polymer or polymer blend that renders the layer(s) more suitable as heat seal bonding layers for thermally bonding the film to a facing. In most embodiments, the strength layer(s) are formed from an olefin polymer such as described above. The strength layer may contain a crosslinkable or non-crosslinkable thermoplastic polymer. Additional film-forming polymers that may be suitable for use with the disclosed elastic laminate structure, alone or in combination with other polymers, include ethylene vinyl acetate, ethylene ethyl acrylate, ethylene acrylic acid, ethylene methyl acrylate, ethylene normal butyl acrylate, nylon, ethylene vinyl alcohol, polystyrene, polyurethane, and combinations thereof.

The thickness of the strength layer(s) is generally selected so as not to substantially impair the elastomeric properties of the film. To this end, each strength layer may separately comprise from about 0.5 to about 15% of the total thickness of the film, and in some embodiments from about 1 to about 10% of the total thickness of the film. For instance, each strength layer may have a thickness of from about 0.1 to about 10 micrometers, in some embodiments from about 0.5 to about 5 micrometers, and in some embodiments, from about 1 to about 2.5 micrometers. Likewise, the base layer may have a thickness of from about from about 1 to about 40 micrometers, in some embodiments from about 2 to about 25 micrometers, and in some embodiments, from about 5 to about 20 micrometers. The strength layer provides both strength and prevents blocking of the elastic material web when wound on a roll.

Although not required, one or more nonwoven web facings may be laminated to the elastic material web to reduce the coefficient of friction and enhance the cloth-like feel of its surface. The basis weight of the nonwoven web facing may generally vary, such as from about 5 to 120 grams per square meter (“gsm”), in some embodiments from about 8 to about 70 gsm, and in some embodiments, from about 10 to about 35 gsm. When multiple nonwoven web facings are used, such materials may have the same or different basis weights.

Exemplary polymers for use in forming nonwoven web facings may include, for instance, polyolefins, e.g., polyethylene, polypropylene, polybutylene, etc.; polytetrafluoroethylene; polyesters, e.g., polyethylene terephthalate; polyvinyl acetate; polyvinyl chloride acetate; polyvinyl butyral; acrylic resins, e.g., polyacrylate, polymethylacrylate, polymethylmethacrylate; polyamides, e.g., nylon; polyvinyl chloride; polyvinylidene chloride; polystyrene; polyvinyl alcohol; polyurethanes; polylactic acid; and copolymers thereof. If desired, biodegradable polymers, such as those described above, may also be employed. Synthetic or natural cellulosic polymers may also be used, including but not limited to, cellulosic esters; cellulosic ethers; cellulosic nitrates; cellulosic acetates; cellulosic acetate butyrates; ethyl cellulose; and regenerated celluloses, such as viscose, rayon. It should be noted that the polymer(s) may also contain other additives, such as processing aids or treatment compositions to impart desired properties to the fibers, residual amounts of solvents, pigments or colorants.

Monocomponent and/or multicomponent fibers may be used to form the nonwoven web facing. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al., U.S. Pat. No. 5,336,552 to Strack, et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

Although any combination of polymers may be used, the polymers of the multicomponent fibers are typically made from thermoplastic materials with different glass transition or melting temperatures where a first component (e.g., sheath) melts at a temperature lower than a second component (e.g., core). Softening or melting of the first polymer component of the multicomponent fiber allows the multicomponent fibers to form a tacky skeletal structure, which upon cooling, stabilizes the fibrous structure. For example, the multicomponent fibers may have from about 5 to about 80% by weight, and more desirably, from about 10 to about 60% by weight of the low melting polymer. Further, the multicomponent fibers may have from about 20 to about 95% by weight, and more desirably, from about 40 to about 90% by weight of the high melting polymer. Some examples of known sheath-core bicomponent fibers are available from KoSa Inc. of Charlotte, N.C. under the designations T-255 and T-256, both of which use a polyolefin sheath, or T-254, which has a low melt co-polyester sheath. Still other known bicomponent fibers that may be used include those available from the Chisso Corporation of Moriyama, Japan or Fibervisions LLC of Wilmington, Del.

Fibers of any desired length may be employed with the nonwoven facing, such as staple fibers, continuous fibers, etc. In one particular embodiment, for example, staple fibers may be used that have a fiber length in the range of from about 1 to about 150 millimeters, in some embodiments from about 5 to about 50 millimeters, in some embodiments from about 10 to about 40 millimeters, and in some embodiments, from about 10 to about 25 millimeters. Although not required, carding techniques may be employed to form fibrous layers with staple fibers as is well known to those skilled in the art. For example, fibers may be formed into a carded web by placing bales of the fibers into a picker that separates the fibers. Next, the fibers are sent through a combing or carding unit that further breaks apart and aligns the fibers in the machine direction so as to form a machine direction-oriented fibrous nonwoven web. The carded web may then be bonded using known techniques to form a bonded carded nonwoven web.

If desired, the nonwoven web facing used to form the nonwoven composite may have a multi-layer structure. Suitable multi-layered materials may include, for instance, spunbond/meltblown/spunbond (SMS) laminates and spunbond/meltblown (SM) laminates. Various examples of suitable SMS laminates are described in U.S. Pat. No. 4,041,203 to Brock et al.; U.S. Pat. No. 5,213,881 to Timmons, et al.; U.S. Pat. No. 5,464,688 to Timmons, et al.; U.S. Patent No. 4,374,888 to Bornslaeger; U.S. Pat. No. 5,169,706 to Collier, et al.; and U.S. Pat. No. 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

Another example of a multi-layered structure is a spunbond web produced on a multiple spin bank machine in which a spin bank deposits fibers over a layer of fibers deposited from a previous spin bank. Such an individual spunbond nonwoven web may also be thought of as a multi-layered structure. In this situation, the various layers of deposited fibers in the nonwoven web may be the same, or they may be different in basis weight and/or in terms of the composition, type, size, level of crimp, and/or shape of the fibers produced. As another example, a single nonwoven web may be provided as two or more individually produced layers of a spunbond web, a carded web, etc., which have been bonded together to form the nonwoven web. These individually produced layers may differ in terms of production method, basis weight, composition, and fibers as discussed above.

A nonwoven web facing may also contain an additional fibrous component such that it is considered a composite. For example, a nonwoven web may be entangled with another fibrous component using any of a variety of entanglement techniques known in the art (e.g., hydraulic, air, mechanical, etc.). In one embodiment, the nonwoven web is integrally entangled with cellulosic fibers using hydraulic entanglement. A typical hydraulic entangling process utilizes high pressure jet streams of water to entangle fibers to form a highly entangled consolidated fibrous structure, e.g., a nonwoven web. Hydraulically entangled nonwoven webs of staple length and continuous fibers are disclosed, for example, in U.S. Pat. No. 3,494,821 to Evans and U.S. Pat. No. 4,144,370 to Boulton, which are incorporated herein in their entirety by reference thereto for all purposes. Hydraulically entangled composite nonwoven webs of a continuous fiber nonwoven web and a pulp layer are disclosed, for example, in U.S. Pat. No. 5,284,703 to Everhart, et al. and U.S. Pat. No. 6,315,864 to Anderson, et al., which are incorporated herein in their entirety by reference thereto for all purposes. The fibrous component of the composite may contain any desired amount of the resulting substrate. The fibrous component may contain greater than about 50% by weight of the composite, and in some embodiments, from about 60 to about 90% by weight of the composite. Likewise, the nonwoven web may contain less than about 50% by weight of the composite, and in some embodiments, from about 10 to about 40% by weight of the composite.

The nonwoven web facing may be necked in one or more directions prior to lamination to the elastic material web. Suitable necking techniques are described in U.S. Pat. Nos. 5,336,545, 5,226,992, 4,981,747 and 4,965,122 to Morman, as well as U.S. Patent Application Publication No. 2004/0121687 to Morman, et al. Alternatively, the nonwoven web may remain relatively inextensible in a direction prior to lamination to the film. In such embodiments, the nonwoven web may be optionally stretched in one or more directions subsequent to lamination to the elastic material.

Any of a variety of techniques may be employed to attach the layers together, including adhesive bonding; thermal bonding; ultrasonic bonding; microwave bonding; extrusion coating; and others known to those skilled in the art. In one particular embodiment, nip rolls apply a pressure to the precursor elastic material (e.g., film) and nonwoven facing(s) to thermally bond the materials together. The rolls may be smooth and/or contain a plurality of raised bonding elements. Adhesives may also be employed, such as Rextac 2730 and 2723 available from Huntsman Polymers of Houston, Tex., as well as adhesives available from Bostik Findley, Inc. of Wauwatosa, Wis. The type and basis weight of the adhesive used will be determined on the elastic attributes desired in the final composite and end use. For instance, the basis weight of the adhesive may be from about 1.0 to about 3.0 gsm. The adhesive may be applied to the nonwoven web facings and/or the elastic material prior to lamination using any known technique, such as slot or melt spray adhesive systems. During lamination, the elastic material may in a stretched or relaxed condition depending on the desired properties of the resulting composite.

Referring back to FIG. 1, the elastic material web 12 may further pass through a cutting assembly 22 to sever the continuously moving elastic material web 12 into the elastic members 20 that are sized in discrete segments to correspond to at least one discrete elasticized portion of the absorbent article. The elastic members are carried by a suitable conveyer means (not shown). The cutting assembly 22 may be any mechanism known to those skilled in the art that can sever a web of material into discrete segments such as, for example, a rotary cutter. Alternatively, the elastic material web may be pre-cut into the discrete segments, and supplied without an additional cutting assembly.

The method and apparatus 10 may further include an adhesive applicator assembly 28 that applies an operative amount of adhesive to the elastic material web 12 or the elastic members 20 for attaching the elastic members 20 to the article web 16. For the sake of clarity, the adhesive will be particularly described as being applied to the elastic material web 12. It will be readily understood by those skilled in the art that in the described embodiments an operative amount of adhesive may be applied by the applicator assembly 28 to discrete elastic members 20 as well as onto the elastic material web 12 (prior to being separated into individual elastic members 20), or to the article web 16 moving in the direction of arrow 17. This arrangement can depend, for example, on where the adhesive applicator assembly 28 may be located relative to the cutting assembly 22 in the method and apparatus 10.

The adhesive applicator assembly 28 may include a bank of one or more adhesive heads for applying adhesive to the elastic material web 12 or elastic members 20. The adhesive may be applied to the elastic material web 12 in any number of selected patterns as are known to those skilled in the art. For example, the adhesive may be applied in a generally rectilinear pattern. The adhesive applicator assembly 28 may apply the adhesive in a spray pattern, a swirl pattern, a slot coat, and the like, or combinations thereof. The elastic material members 20 are then attached to the article web 16. For example, a nip roll assembly 24 may be utilized to cause the adhesive 72 to attach the elastic member to the article web 16. Alternatively, the elastic material web 12 may be attached to the article web 16 by any suitable method known in the art, such as pressure bonding, ultrasonic bonding, welding, sewing, or mechanical bonding, and the like, or combinations thereof.

Desirably, once the elastic material 12 or elastic members 20 are attached to the absorbent article web 16, it may be crosslinked by passing it through an electromagnetic radiation source 26. The elastic material web 12 or elastic members 20 may be crosslinked after attachment to the absorbent article web as shown, or before lamination to the absorbent article web.

The elastic members 20 may be incorporated onto the absorbent article web 16 and subsequently crosslinked. In this manner, the material is not highly elastic prior to crosslinking and is thus more dimensionally stable than highly elastic materials. This decreases the need for maintaining the material in a mechanically stretched condition during attachment to other components of the absorbent article and thus provides greater freedom in the location and manner in which the components are attached together. The elastic material web 12 may also be crosslinked prior to being attached onto the absorbent article. The benefits of crosslinking the elastic material webs on the diaper manufacturing line include, without limitation, a) less aging behavior of the non-crosslinked elastic structure (prior to conversion), as evidenced by little or no loss in tension when the elastic structure is wound and stored on a roll, b) better temperature stability (same as above), evidenced by the ability to store and transport the elastic material without refrigeration, and c) stronger adhesion, if the elastic material web 12 is crosslinked after attachment to the absorbent article. Additionally, the elastic material web may be extrusion cast, which does not require stretching of the elastic material web. This reduces breakage of the elastic material web during processing reducing downtime of the machinery.

Desirably, the crosslinking of the electron beam radiation may penetrate through laminates, regardless of color or reflectivity of the laminates, and results in high clarity of the laminated structure. Additionally, electron beam radiation instantaneously cures adhesives thereby enabling in-line finishing of an absorbent article.

The electromagnetic radiation source 26 used to cross-link the elastic material web provides electromagnetic radiation sized to correspond to the discrete component of the absorbent article that is being crosslinked. For example, the processing unit may be sized to correspond to the side panel and provide an output of radiation of between about 1 and 6 inches to match the width of the side panel. Since the cost of such equipment is very much dependent on the size of the electron emitting filament, an apparatus of this nature should reduce the cost of manufacture of such equipment. Additionally, by sizing the equipment to correspond to the discrete components of the absorbent article, the machinery can be more easily retro-fit into the diaper converting line. Finally, the radiation source may be controlled to provide pulses of radiation at defined moments that correspond to the discrete elasticized portion saving energy costs.

The electromagnetic radiation source 26 may emit or apply electron beam or e-beam radiation, ultraviolet radiation, gamma radiation, or another suitable media to the elastic material web to affect crosslinking of the styrenic block copolymer.

The amount of radiation required will depend on the line speed, the amount of crosslinking desired, the type of radiation used, and the thickness and/or the specific composition of the elastic material web. The elastic material web is considered to be a “crosslinked elastic material web” when its percent load loss is reduced by at least 5% compared to its percent load loss prior to crosslinking, using the test procedure described below. For example, if an elastic material web demonstrates a percent load loss of 65% prior to crosslinking, then the elastic material web will be considered crosslinked if a crosslinking treatment causes its percentage load loss to fall to not more than 60% (a 5% reduction). More desirably, the percent load loss is reduced by at least 10% compared to its percent load loss prior to crosslinking, or even more desirably at least a 20% reduction.

The processing unit 26 may be an electron beam processing unit having an open or a closed configuration. Suitable electron beam units include low voltage units designed for web based application. “Low voltage” refers to units with output voltages ranging between 0-500 kV. Examples of electron beam processing units suitable for use in the apparatus include, but are not limited to, units from the BROADBEAM line of industrial electron beam processors available from PCT Engineered Systems, LLC of Davenport, Iowa; units from the ELECTROCURTAIN line of industrial electron beam processors available from Energy Sciences, Inc. of Wilmington, Mass.; and units from the AEB modular line of industrial electron beam processors available from Advanced Electron Beams of Wilmington, Mass.

When supplying electromagnetic radiation, it is generally desired to selectively control various parameters of the radiation to enhance the degree of crosslinking of the styrenic block copolymer. For example, the electromagnetic radiation source 26 may operate between about 50 to about 500 kV, more desirably between about 100 to about 300 kV, or about 150 kV. Another parameter that may be controlled is the wavelength λ of the electromagnetic radiation. Specifically, the wavelength λ of the electromagnetic radiation varies for different types of radiation of the electromagnetic radiation spectrum. Although not required, the wavelength λ of the electromagnetic radiation used in the present invention is generally about 1000 nanometers or less, in some embodiments about 100 nanometers or less, and in some embodiments, about 1 nanometer or less. Electron beam radiation, for instance, typically has a wavelength λ of about 1 nanometer or less. Besides selecting the particular wavelength λ of the electromagnetic radiation, other parameters may also be selected to optimize the degree of crosslinking. For example, higher dosage and energy levels of radiation will typically result in a higher degree of crosslinking; however, it is generally desired that the materials not be “overexposed” to radiation. Such overexposure may result in an unwanted level of product degradation. The electron beam processing unit may deliver about 2 to about 30 MRads, more desirably about 5 to about 15 MRads or about 10 MRads of electron beam radiation to the elastic material web. The electromagnetic radiation source 26 could be configured to fire electrons at the elastic material webs from the top, bottom, side or any other firing position. The electromagnetic radiation source 26 could have a single vacuum chamber with two electron emitting filaments that bombard the elastic component of the product or it could have two separate chambers with the electron emitting filaments.

Although not shown, various additional potential processing and/or finishing steps known in the art, such as slitting, treating, printing graphics, etc., may be performed without departing from the spirit and scope of the method and apparatus described herein. For instance, the elastic material web may optionally be mechanically stretched in the cross-machine and/or machine directions to enhance extensibility. In one embodiment, the elastic material web may be coursed through two or more rolls that have grooves in the CD and/or MD directions. Such grooved satellite/anvil roll arrangements are described in U.S. Patent Application Publication Nos. 2004/0110442 to Rhim, et al. and 2006/0151914 to Gerndt, et al., which are incorporated herein in their entirety by reference thereto for all purposes. For instance, the composite may be coursed through two or more rolls that have grooves in the CD and/or MD directions. The grooved rolls may be constructed of steel or other hard material (such as a hard rubber). If desired, heat may be applied by any suitable method known in the art, such as heated air, infrared heaters, heated nipped rolls, or partial wrapping of the composite around one or more heated rolls or steam canisters, etc. Heat may also be applied to the grooved rolls themselves. It should also be understood that other grooved roll arrangement are equally suitable, such as two grooved rolls positioned immediately adjacent to one another. Besides grooved rolls, other techniques may also be used to mechanically stretch the composite in one or more directions. For example, the composite may be passed through a tenter frame that stretches the composite. Such tenter frames are well known in the art and described, for instance, in U.S. Patent Application Publication No. 2004/0121687 to Morman, et al. The composite may also be necked. Suitable necking techniques are described in U.S. Pat. Nos. 5,336,545, 5,226,992, 4,981,747 and 4,965,122 to Morman, as well as U.S. Patent Application Publication No. 2004/0121687 to Morman, et al., all of which are incorporated herein in their entirety by reference thereto for all purposes.

### Test Methods

### Load-Elongation

The load-elongation behavior of the test samples was obtained at room temperature using MTS 10/GL electromechanical test frames equipped with data acquisition capability (available from Material Testing System of Eden Prairie, Minn.). Laminate samples in a rectangular shape, 3″ wide and 7″ long were clamped at a grip to grip distance of 3″ and were pulled at a cross-head speed of 20″/min. Samples were taken to failure. The load and displacement were documented. The elongation of the sample is the amount of displacement as a percent of the 3″ starting length.

### Stress Relaxation

Stress Relaxation (SR) of the test samples at body temperature is used for studying the effect of cross-linking on the elastic properties. Stress relaxation is obtained by measuring the force required to maintain a constant elongation over a period of time. Hence, it is a transient response which mimics how personal care products behave in use. In these experiments, the load loss (stress relaxation) as a function of time is measured at body temperature. The rate of load loss as a function of time is obtained by calculating the slope of a log-log regression of the load and time. In addition, the loss at the end of a certain time that corresponds to the time that a product might stay on the body in real use was also calculated from knowledge of the initial and final loads. A perfectly elastic material, such as a metal spring, for instance, is expected to give a value of zero for both slope and load loss thus time independent behavior.

In the stress relaxation characterization, a 3″×7″ specimen was used for the test. Samples were tested in an MTS QTest/50LP electromechanical frame equipped with 5 load cells (available from Material Testing System of Eden Prairie, Minn.). The samples are enclosed in an environmental chamber at 100° F. An initial 3″ grip-to-grip distance was displaced to a final 4.5″ (50%) at a cross-head displacement speed of 20″/min. The load loss as a function of time was then acquired over a period of 12 hours at 100° F. using the Testworks software capability of the MTS test equipment.

### Hysteresis

The hysteresis behavior of the test samples was obtained by ramping a 3″×7″ rectangular specimen clamped in the gauges at a grip-to-grip distance of 3″ to the desired elongation and down to 0% elongation at 20 inches/min using an MTS 10/GL electromechanical frame, at room temperature. The data was acquired at 100 samples/second, to give a well-defined loop. Data thus collected was further smoothed by the test software. The loading and unloading energies were calculated by the numerical integration of the smoothed data. The difference in energy between loading and unloading curves was divided by the initial loading energy and multiplied by 100 to obtain the percentage hysteresis.

### EXAMPLE

A three layer elastic film with a strength layer positioned between two surface layers was cast onto a chill roll where it came in contact with a first layer of polyethylene spun bonded facing. An opposing layer of polyethylene spun bonded facing was brought into contact with the second face of the film to make the laminate. The two surface layers of the elastic film used was formed with a styrenic block copolymer SIBS (D1171) from Kraton Polymers LLC of Houston, Tex. while the strength layer consisted of PEBAX 2080 elastomer obtained from Arkema Inc. of Philadelphia, Pa. The basis weight of the film was 50 gsm (40 gsm D1171+10 gsm PEBAX 2080). The basis weight of each polyethylene facing was 20 gsm. Each polyethylene facing consisted of 80% Aspun 6850A and 20% of Infuse Olefinic block Copolymer, both from Dow Chemical, USA. The total basis weight of the laminate was 90 gsm. The laminate was then treated with electron beams and pre-stretched to obtain stretchable elastic material in the CD direction of the laminate. The electron beam processing equipment was purchased from Advanced Electron Beam of Wilmington, Mass. This sample is referred to as Example below. A Comparative Example was prepared in the same way but without the treatment with the electron beams.

FIG. 3 shows the normalized load as a function of percentage elongation at room temperature (about 20° C.) calculated via the Load-Elongation Test. As illustrated, the Example has better load-elongation response than the Comparative Example, indicating an improvement of elasticity/toughness of the material after crosslinking.

Lower values for load loss and slope of the load loss curve calculated via the Stress Relaxation Test are illustrative of a better performing elastic material. The 12-hour body temperature load loss and slope of the load loss curve over time of the Example was found to display very good elastic characteristics, with a load loss of only 49%, and a negative slope of just 0.08. The Comparative Example was found to display less desirable elastic characteristics, with a load loss of 56%, and a negative slope of 0.11. This behavior of these materials' parameters suggests that the process of electron beam treatment introduces an improvement of elasticity.

Another way of measuring how well elastic materials perform is by measuring their hysteresis. Hysteresis is a measure of whether or how well an elastic material retains its elastic properties over a number of stretches, and the percentage hysteresis over a number of stretch cycles should desirably be minimal. The Example has a percentage hysteresis value of 49%. The Comparative Example has a percentage hysteresis value of 58%. The lower percentage hysteresis value illustrates the crosslinked elastic material retains its elastic properties for a longer period to time.

It will be appreciated that the foregoing examples, given for purposes of illustration, are not to be construed as limiting the scope of this disclosure. Although only a few exemplary embodiments have been described in detail above, those skilled in the art will readily appreciate that many modifications are possible in the exemplary embodiments without materially departing from the novel teachings and advantages of this disclosure. Accordingly, all such modifications are intended to be included within the scope of this disclosure, which is defined in the following claims and all equivalents thereto.

1. A method of forming a discrete elasticized portion of an absorbent article comprising:
providing a base web for manufacturing an absorbent article on an absorbent article manufacturing line;
supplying an elastic material web comprising at least one cross-linkable elastic styrenic block copolymer sized to correspond to at least one discrete elasticized portion of the absorbent article, the elastic material web further comprises at least one facing layer, the facing layer comprising a nonwoven web selected from meltblown, spunbond and combinations thereof;
attaching the elastic material web to the base web to form the at least one discrete elasticized portion of the absorbent article;
subjecting the elastic material web to electromagnetic radiation with an electromagnetic radiation source sufficient to provide a crosslinked elastic styrenic block copolymer, wherein the electromagnetic radiation is sized to correspond to the at least one discrete elasticized portion of the absorbent article;
wherein the at least one discrete elasticized portion of the absorbent article is crosslinked after being attached to the base web on the absorbent article manufacturing line.

2. (canceled)

3. The method of claim 1 wherein the elastic material web further comprises at least one strength layer, the strength layer comprising a crosslinkable or non-crosslinkable thermoplastic polymer.

4. The method of claim 1 wherein the at least one discrete elasticized portion of the absorbent article is selected from side panels, leg elastics, stretch ears, flaps, waistband materials, and cover materials.

5. (canceled)

6. The method of claim 1 wherein the electromagnetic radiation has a wavelength of about 100 nanometers or less.

7. The method of claim 1 wherein the electromagnetic radiation has a wavelength of about 1 nanometer or less.

8. The method of claim 1 wherein the electromagnetic radiation is electron beam radiation.

9. The method of claim 1 wherein the at least one discrete elasticized portion of the absorbent article is subjected to a dosage from about 1 to about 30 Mrads.

10. The method of claim 1 wherein the at least one discrete elasticized portion of the absorbent article is subjected to a dosage from 5 to about 15 Mrads.

11. An apparatus for forming an elastic portion of an absorbent article comprising:
a supplying mechanism for supplying an elastic material web comprising at least one cross-linkable elastic styrenic block copolymer sized to correspond to at least one discrete elasticized portion of the absorbent article;
an attachment mechanism for attaching the elastic material web to the absorbent article to form the at least one discrete elasticized portion of the absorbent article;
an electromagnetic radiation source for subjecting the elastic material web to electromagnetic radiation wherein the electromagnetic radiation output is sized to correspond to the at least one discrete elasticized portion of the absorbent article and sufficient to provide a crosslinked elastic styrenic block copolymer.

12. The apparatus of claim 11 wherein the elastic material web further comprises at least one facing layer, the facing layer comprising a nonwoven web selected from meltblown, spunbond and combinations thereof.

13. The apparatus of claim 11 wherein the elastic material web further comprises at least one strength layer, the strength layer comprising a crosslinkable or non-crosslinkable thermoplastic polymer.

14. The apparatus of claim 11 wherein the at least one discrete elasticized portion of the absorbent article is selected from side panels, leg elastics, stretch ears, flaps, waistband materials, and cover materials.

15. The apparatus of claim 11 wherein the electromagnetic radiation has a wavelength of about 100 nanometers or less.

16. The apparatus of claim 11 wherein the electromagnetic radiation has a wavelength of about 1 nanometer or less.

17. The apparatus of claim 11 wherein the electromagnetic radiation is electron beam radiation.

18. The apparatus of claim 11 wherein the at least one discrete elasticized portion of the absorbent article is subjected to a dosage from 1 to about 30 Mrads.

19. The apparatus of claim 11 wherein the at least one discrete elasticized portion of the absorbent article is subjected to a dosage from 5 to about 15 Mrads.

20. The method of claim 1 wherein the at least one discrete elasticized portion of the absorbent article is crosslinked after being attached to the base web.
